(19) United States
(12) Patent Application Publication
(10) Pub. No.: US 2024/0030746 A1
(43) Pub. Date: Jan. 25, 2024

(54) SOLENOID COIL UNIT AND CONTACTLESS POWER FEEDING DEVICE

(71) Applicant: Wireless Power Transfer Co., Ltd, Aichi (JP)

(72) Inventors: Takashi KIMURA, Nagoya-shi (JP); Mikine ITO, Nagoya-shi (JP)

(73) Assignee: Wireless Power Transfer Co., Ltd, Aichi (JP)

(21) Appl. No.: 18/014,966

(22) PCT Filed: Nov. 4, 2021
(86) PCT No.: PCT/JP2021/040668

§ 371 Date: Jun. 5, 2023

(30) Foreign Application Priority Data
Nov. 6, 2020 (JP) 2020-185892
Mar. 17, 2021 (JP) 2021-043014
Jul. 16, 2021 (JP) 2021-118348

(51) Int. Cl. H02J 50/10; H01F 38/14

(52) U.S. Cl. CPC H02J 50/10; H01F 38/14

(57) ABSTRACT

A solenoid coil unit is provided with a solenoid coil that is to be arranged in parallel with another solenoid coil with a predetermined gap in a separation direction orthogonal to a center axis direction; and a rod-shaped core around which the solenoid coil is wound and having a length longer than the length of the solenoid coil in the center axis direction. The rod-shaped core has a center portion around which the solenoid coil is wound and end portions located at both ends of the rod-shaped core and extending from both ends of the solenoid coil, the ratio of the length to the width of the center portion is 2 or more, and the length of the solenoid coil in the center axis direction is approximately twice the gap.

### TECHNICAL FIELD

This disclosure relates to a contactless power transfer device that transmits power from a power transmitting side to a power receiving side by magnetic field coupling, and a solenoid coil unit used in the contactless power transfer device.

### BACKGROUND ART

In recent years, contactless power transfer devices that transmit electric power to electronic devices and electric vehicles without using cables have attracted attention. This technology enables electric vehicles equipped with a power-receiving unit to be charged contactlessly using a power-transmitting unit installed in a parking lot, or to be charged contactlessly using a power-transmitting unit installed in the road while the vehicle is running.

The types of coil units used in contactless power transfer devices can be roughly divided into the circular type shown in FIGS. 16A, 16B and the solenoid type shown in FIGS. 16C, 16D. As shown in FIGS. 16A and 16B, the circular-type coil unit 100A has a configuration in which a coil 101A is concentrically wound on one side of a disk-shaped ferrite core 102A, and is also called a single-sided winding type. As shown in FIGS. 16C and 16D, the solenoid coil unit 100B has a configuration in which a coil 101B is wound around a flat ferrite core 102B, and is also called a double-sided winding type.

In both types, increasing the transmission efficiency as a contactless power transfer device is an extremely important issue because the decrease in the efficiency of power transmission not only increases the transmission loss but also causes heat generation. It is known that increasing the coupling coefficient k between the power-transmitting unit and the power-receiving unit to increase the Q value of the coil is an important factor for increasing transmission efficiency.

In general, a circular-type coil unit has a high coupling coefficient k but also has a small tolerance for misalignment between the power-transmitting unit and the power-receiving unit. In contrast, as described in Patent Document 1, it is said that the solenoid coil unit has a characteristic that allows a large amount of tolerance for misalignment, although the leakage magnetic flux is present at the back and the coupling coefficient is slightly lower. The tolerance for misalignment between the power-transmitting unit and the power-receiving unit is called “robustness”, which is a major issue for social implementation of contactless power transfer.

As for contactless power transfer technology for electric mobility such as hybrid and electric vehicles, technology that enables power supply while driving will be needed in the future. In the case of power supplying while vehicle running, it is necessary to ensure high robustness against misalignment in the forward-backward travel direction of the vehicle and misalignment in the lateral direction which is the direction orthogonal to the forward-backward travel direction.

FIG. 17 illustrates a graph showing robustness in each solenoid-type coil unit with an H-shaped core and circular-type coil unit, in accordance with FIG. 4.2 in Non-patent Document 1. Graphs Hx and Hy show changes in the coupling coefficient due to misalignment in the x- and y-directions of solenoid-type coil units, respectively, and graph Cr shows changes in the coupling coefficient due to misalignment of circular-type coil units. When the amount of misalignment shown on the horizontal axis increases, the coupling coefficient of the circular-type coil unit decreases rapidly and the circular unit is unable to transmit power. In the case of a solenoid coil unit using an H-shaped core, the robustness against misalignment is higher than that of the circular-type coil unit by the virtue of the characteristics of the solenoid coil. However, due to the characteristics of the shape of the H-shaped core, the coupling coefficient might be significantly reduced depending on the direction and amount of misalignment, and there is still room for improvement.

In addition, when considering contactless power transfer for an electric vehicle, the gap between the power-transmitting coil unit and the power-receiving coil unit will be approximately 100 to 250 mm, depending on the vehicle type. A specifically designed coil unit that can cope with this gap may be to heavy when conventional circular or solenoid coil unit is employed. In this regard, Patent Document 1 discloses a solenoid coil unit employing an H-shaped core in which the width of the coiled portion of the flat core around which the coil is wound is narrower than the width of the magnetic pole portion around which the coil is not wound, for the purpose of reducing the weight of the coil unit.

Using the H-shaped core disclosed in Patent Document 1, the solenoid coil unit can be made lighter than the conventional flat core. However, according to the details of the experimental conditions disclosed in Non-patent Document 2, the coil unit is designed assuming the gap between the coils being around 70 to 100 mm. To cope with a gap of about 200 mm while maintaining power transferring performance, the solenoid coil unit might be larger, and as a result, further weight reduction might be necessary for practical use of the H-shaped core. The weight of the coil units used in the demonstration experiments so far actually has ranged from tens of kilograms to 100 kilograms, depending on the power output, indicating that it is not practical to mount them on a vehicle.

### CITATION LIST

### Patent Literature

Patent Document 1: JP 2011-50127 A

### Non-Patent Literature

Non-patent Document 1: Jun Yamada Dissertation, “Basic Study of Coil Shape and Resonant Circuit System Suitable for Contactless Power Transfer in Running Electric Vehicles,” March 2018, Graduate School of Science and Engineering, Saitama University
Non-patent Document 2: “Small-size Light-weight Transformer with New Core Structure for Contactless Power Transfer System of Electric Vehicle,” Chigira, Nagatsuka, Kaneko, Abe, Yasuda, and Suzuki (SPC-11-048)

### SUMMARY OF INVENTION

### Technical Problem

As described above, a certain weight reduction and robustness can be achieved by using a solenoid coil unit employing an H-shaped core disclosed in Patent Document 1. However, considering the full-fledged social implementation of contactless power transfer that is about to start and the choice of coil system in anticipation of dynamic power transfer, it is not possible to say that the state has reached a level where the coupling coefficient, robustness, and weight reduction are all sufficient.

The purpose of this disclosure is to provide a solenoid coil unit that improves “coupling coefficient” and “robustness” while achieving “weight reduction”, and a contactless power transfer device that uses this solenoid coil unit, with the goal of a full-fledged social implementation of contactless power transfer.

### Solution to Problem

A first aspect to solve the above problems is provided as a solenoid coil unit that transfers power with another solenoid coil unit in a non-contact manner. The solenoid coil unit of this aspect includes: a solenoid coil that is to be arranged in parallel with another solenoid coil provided in the other solenoid coil unit with a predetermined gap in a separation direction orthogonal to a center axis direction; and a rod-shaped core around which the solenoid coil is wound and having a length longer than the length of the solenoid coil in the center axis direction. The rod-shaped core has a center portion around which the solenoid coil is wound and end portions extending from both ends of the solenoid coil, wherein the center portion has a ratio of the length to the width of 2 or more, and the solenoid coil has a length in the center axis direction that is approximately twice the gap.

In a second aspect, the ratio of the length to the width of the center portion may be 8 or more.

In a third aspect, the relation 2≤L/w≤16 may be satisfied, in which L represents the length of the center portion and w represents the width of the center portion.

In a fourth aspect, the coupling coefficient k may be 0.17 or more and less than 0.2 when the other solenoid coil unit comprising the other solenoid coil of the same configuration as the solenoid coil and the other rod-shaped core of the same configuration as the rod-shaped core is arranged without misalignment with the gap of 200 mm with respect to the solenoid coil unit.

In a fifth aspect, the end portion may be provided with plate-like additional magnetic pole portions that are smaller in thickness than the center portion and extend from the end portions.

In a sixth aspect, the length of the additional magnetic pole portions may be greater than the width of the center portion.

In a seventh aspect, the length and width of the additional magnetic pole portions may be approximately equal.

An eighth aspect is provided as a contactless power transfer device. The contactless power transfer device of this aspect includes; a first solenoid coil unit which is a solenoid coil unit of any of the above aspects, and a second solenoid coil unit which is the other solenoid coil unit, to transfer power by causing mutual induction between the first solenoid coil unit and the second solenoid coil unit.

### Advantageous Effects of Invention

According to the solenoid coil unit of the first aspect, the rod-shaped core can be constituted in an elongated shape with a length according to the gap, so that a high coupling coefficient can be achieved while suppressing the increase in weight even if the gap between the solenoid coil unit and the other solenoid coil unit increases. In addition, a solenoid coil unit equipped with such an elongated rod-shaped core can suppress decrease in coupling coefficient due to misalignment, and achieve high robustness, compared with a conventional disk-shaped core, plate-shaped flat core, or H-shaped core, among others. Therefore, the solenoid coil unit of the first aspect can improve the coupling coefficient and robustness while reducing the weight.

The solenoid coil unit of the second aspect can make the rod-shaped core into a more elongated shape, thereby further increasing the coupling coefficient while suppressing the increase in the weight of the solenoid coil unit. This configuration can also achieve high robustness at the same time.

The solenoid coil unit of the third aspect can prevent the coupling coefficient between the solenoid coil unit and the other solenoid coil unit from being significantly low while preventing the weight from being significantly heavy. Therefore, this configuration can further improve the coupling coefficient and robustness while reducing the weight.

The solenoid coil unit of the fourth aspect can suppress the weight increase and further improve the coupling coefficient of the solenoid coil unit. Therefore, this configuration can still further improve the coupling coefficient and robustness while reducing the weight.

By providing additional magnetic pole portions, the solenoid coil of the fifth aspect can improve the coupling coefficient even when reducing the size of the center portion of the rod-shaped core. In addition, since the additional magnetic pole portions can be made lighter by reducing the thickness thereof, it is possible to effectively increase the coupling coefficient while suppressing the increase in the weight of the solenoid coil. The additional magnetic pole portions, if provided, can further suppress the reduction of the coupling coefficient due to misalignment with respect to the other solenoid coil unit. Therefore, this configuration can further improve the coupling coefficient and robustness while reducing the weight.

The solenoid coil of the sixth aspect enlarges the additional magnetic pole portions in the width direction, thereby achieving higher coupling coefficient and robustness.

The solenoid coil unit of the seventh aspect enlarges the additional magnetic pole portions in both the center axis direction and the width direction. Therefore, this configuration can further improve the robustness against misalignment in both the center axis direction and width direction with respect to the other solenoid coil unit while increasing the coupling coefficient.

The contactless power transfer device of the eighth aspect, including the solenoid coil unit of one of the above aspects, can further improve the coupling coefficient and robustness while reducing the weight.

### BRIEF DESCRIPTION OF DRAWINGS

FIG. 1A is a schematic plan view of a solenoid coil unit according to a first embodiment.

FIG. 1B is a schematic front view of the solenoid coil unit according to the first embodiment.

FIG. 1C is a schematic side view of the solenoid coil unit according to the first embodiment.

FIG. 2 is a schematic diagram illustrating a configuration of a contactless power transfer device using the solenoid coil unit according to the first embodiment.

FIG. 3 is a schematic diagram illustrating magnetic flux generated by a pair of solenoid coil units.

FIG. 4 is an explanatory diagram illustrating a graph showing the relation between the length of the solenoid coil and the coupling coefficient.

FIG. 5 is an explanatory diagram illustrating a graph showing the relation between magnetic permeability and the coupling coefficient.

FIG. 6 is an explanatory diagram illustrating a graph showing the relation between the cross-sectional area of the rod-shaped core and the coupling coefficient.

FIG. 7 is an explanatory diagram illustrating a graph showing the relation between the ratio of the coupling coefficient to the cross-sectional area of the rod-shaped core and the cross-sectional area of the rod-shaped core.

FIG. 8A is a schematic plan view of a solenoid coil unit according to a second embodiment.

FIG. 8B is a schematic front view of the solenoid coil unit according to the second embodiment.

FIG. 8C is a schematic side view of the solenoid coil unit according to the second embodiment.

FIG. 9 is a schematic diagram illustrating a configuration of a contactless power transfer device using the solenoid coil unit according to the second embodiment.

FIG. 10 is an explanatory diagram illustrating a graph showing the relation between the dimension of the additional magnetic pole portions and the coupling coefficient.

FIG. 11 is an explanatory diagram illustrating a graph showing the relation between the area of the additional magnetic pole portions and the coupling coefficient.

FIG. 12 is an explanatory diagram illustrating a graph showing the relation between the gap and the coupling coefficient.

FIG. 13 is a schematic view illustrating a state of a pair of solenoid coil units misaligned in the width direction.

FIG. 14 is a schematic view illustrating a state of a pair of solenoid coil units misaligned in the center axis direction.

FIG. 15 is an explanatory diagram illustrating a graph showing the relation between the amount of misalignment and the coupling coefficient.

FIG. 16A is a schematic plan view of a circular-type coil unit used in a conventional contactless power transfer device.

FIG. 16B is a schematic side view of a circular-type coil unit used in a conventional contactless power transfer device.

FIG. 16C is a schematic plan view of a solenoid-type coil unit used in a conventional contactless power transfer device.

FIG. 16D is a schematic side view of a solenoid-type coil unit used in a conventional contactless power transfer device.

FIG. 17 is an explanatory diagram illustrating a graph showing robustness in a conventional coil unit.

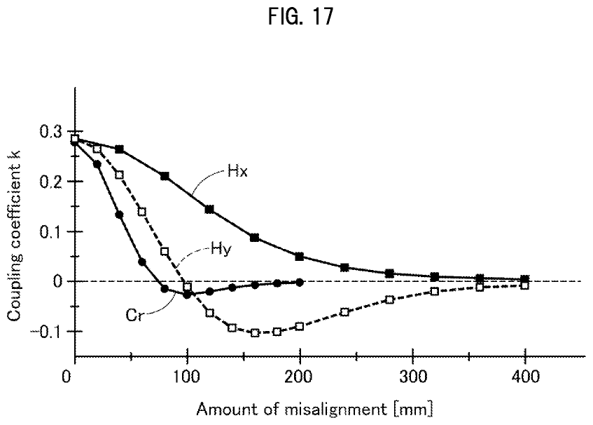

FIG. 18A, FIG. 18B, and FIG. 18C each show a shape of core of a solenoid type.

### DESCRIPTION OF EMBODIMENTS

Embodiments of the solenoid coil unit and the contactless power transfer device of the present disclosure are described below in detail with reference to the drawings.

### 1. First Embodiment

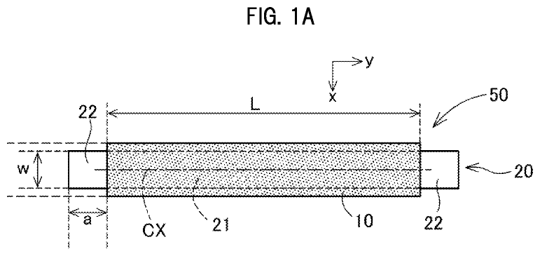

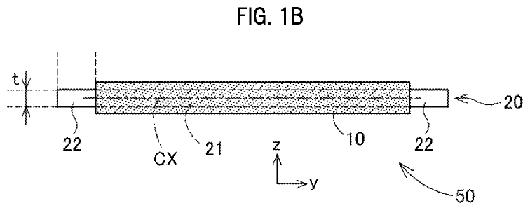

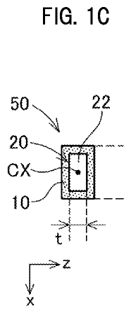

FIGS. 1A, 1B, and 1C illustrates schematic plan view, schematic front view, and schematic side view of a solenoid coil unit 50 according to a first embodiment, respectively. The solenoid coil unit 50 includes a solenoid coil 10.

FIGS. 1A and 1B show the center axis CX of the solenoid coil 10 by a dash-dotted line. Hereafter, the direction along the center axis CX is also referred to simply as the “center axis direction”. FIGS. 1A, 1B, and 1C show arrows indicating the y-direction corresponding to the center axis direction, the x-direction orthogonal to the y-direction, and the z-direction described below orthogonal to the x- and y-directions, respectively. The x-direction corresponds to the “width direction” that is orthogonal to the center axis direction and the separation direction described below. In the following, with respect to the dimensions of the solenoid coil unit, “length” means the dimension in the y-direction, “width” means the dimension in the x-direction, and “thickness” means the dimension in the separation direction orthogonal to the x- and y-directions.

The solenoid coil 10 is formed by tightly winding an insulation-coated wire in a spiral and generates a magnetic field in the center axis direction by an electric current flowing through the wire. It is desirable that the wire is wound uniformly and regularly to reduce magnetic flux disturbance and leakage as much as possible. The length of the solenoid coil 10 is represented as L. It should be noted that the figure does not depict each wire. The winding direction of the wire in the solenoid coil 10 is the direction along the x-direction.

The solenoid coil unit 50 further includes a rod-shaped core 20 around which the solenoid coil 10 is wound. The center axis of the rod-shaped core 20 coincides with the center axis CX of the solenoid coil 10, and the y-direction corresponds to the longitudinal direction of the rod-shaped core 20. The rod-shaped core 20 is composed of a ferromagnet such as ferrite, for example. The cross-sectional shape of the longitudinal vertical cross section of the rod-shaped core 20 is not particularly limited and may be approximately quadrilateral as shown, or may be circular or elliptical.

The rod-shaped core 20 is made longer than the length L of the solenoid coil. The rod-shaped core 20 has a center portion 21 wound around the solenoid coil 10 and end portions 22 located at both ends of the rod-shaped core 20 and extending from both ends of the solenoid coil 10. The length of the solenoid coil 10 coincides with the length L of the solenoid coil. Hereafter, the length of the center portion 21 is also denoted as “L”. A pair of end portions 22 of the rod-shaped core 20 function as magnetic poles of the solenoid coil unit 50.

As shown in FIGS. 1A, 1B, and 1C, the thickness t of the rod-shaped core 20 is smaller than the length L of the center portion 21 and the width w of the rod-shaped core 20. The thickness of the rod-shaped core 20 is not particularly limited and may be, e.g., the width of the center portion 21 or more.

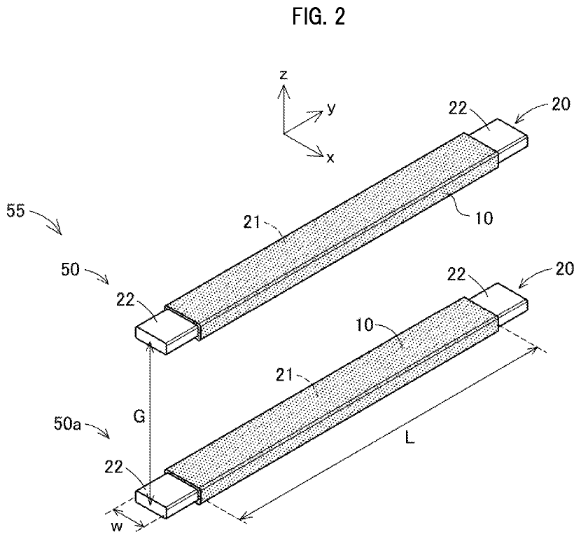

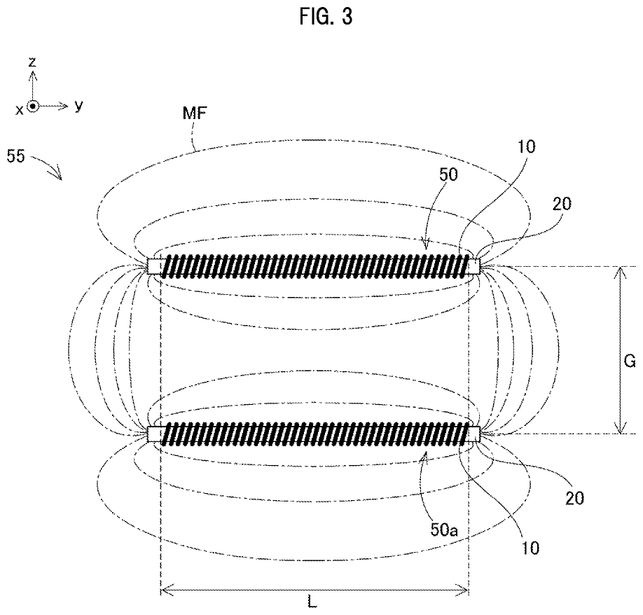

FIGS. 2 and 3 are schematic diagrams showing a pair of solenoid coil units 50, 50a arranged in parallel by a predetermined gap G, corresponding to a separation distance, between them. In FIG. 3, the magnetic flux MF is illustrated by a dash-dotted line. Furthermore, the electric wire constituting the solenoid coil 10 is schematically illustrated in FIG. 3.

The pair of solenoid coil units 50, 50a constitute a contactless power transfer device 55, and the solenoid coil unit 50 transfers power to and from the other solenoid coil unit 50a, which is spaced apart, in a non-contact manner. Hereafter, the solenoid coil unit 50 of this embodiment is also referred to as the “first solenoid coil unit 50” and the other solenoid coil unit 50a is also referred to as the “second solenoid coil unit 50a”.

In this embodiment, the second solenoid coil unit 50a has the same configuration as the first solenoid coil unit 50. The second solenoid coil unit 50a includes the solenoid coil 10 of the same configuration as the first solenoid coil unit 50 and the rod-shaped core 20, and has the same self-inductance as the first solenoid coil unit 50.

In the contactless power transfer device 55, the two solenoid coil units 50, 50a are arranged in parallel, separated in the separation direction. The “separation direction” here corresponds to the z-direction orthogonal to the x- and y-directions, and corresponds to the thickness direction of the rod-shaped core 20. In this specification, “parallel” means a state in which one straight line is along another straight line, and this is a concept that includes a state in which two straight lines are arranged mathematically exactly “parallel” and a state in which one straight line has an inclination angle of several degrees with respect to another straight line.

In the contactless power transfer device 55, the second solenoid coil unit 50a is separately arranged without misalignment by the gap G. In other words, in the contactless power transfer device 55, the first solenoid coil unit 50 is arranged at a position overlapping the second solenoid coil unit 50a when viewed in the separation direction. With this arrangement, as shown in FIG. 3, part of the magnetic flux MF generated in one of the pair of solenoid coil units 50, 50a by electric current flowing through the one solenoid coil unit passes through the rod-shaped core 20 of the solenoid coil 10 constituting the other solenoid coil unit and returns to the one solenoid coil unit, thereby causing mutual induction to transfer power. In this specification, unless otherwise noted, the term “coupling coefficient” refers to the value obtained when two coils of the same configuration, arranged in parallel and separated in the separation direction, are arranged without misalignment, as shown in FIGS. 2 and 3.

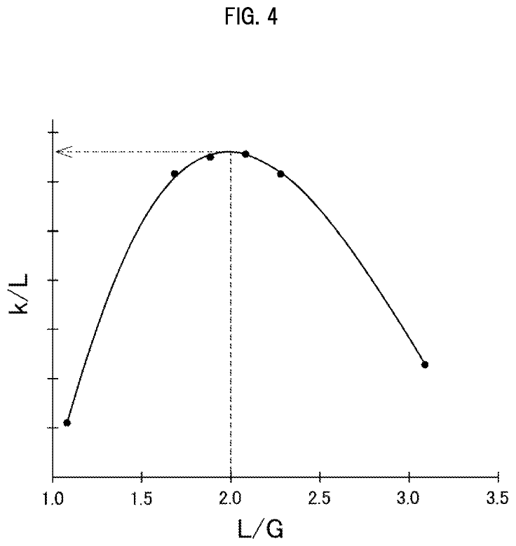

FIG. 4 is a graph showing the relation between the length L of the solenoid coil with respect to the gap G and the coupling coefficient k with respect to the length L when two solenoid coils of the same configuration are arranged in parallel by the gap G. In order to achieve the most efficient coupling coefficient k, the inventors of the present invention carefully examined the relation between the gap G between a pair of solenoid coils and the length L of the solenoid coils by using experiments and simulations. The gap G is determined according to the application of the contactless power transfer device 55, and 200 mm is employed here as an example assuming contactless power transfer to an electric vehicle. In this case, as shown in FIG. 4, it was found that the length L of the solenoid coil, which can achieve the most efficient coupling coefficient k, is about twice the gap G, i.e., L≅2G. In the experimental example examined by the inventors of the present invention, when G=200 mm and L=400 mm, the value of the coupling coefficient k was 0.088.

Designing the solenoid coil unit in the range of L<2G makes it difficult to achieve sufficient coupling coefficient k, and designing in the range of L>2G makes the solenoid coil unit larger than necessary which hinders weight reduction. Note that the relation shown in FIG. 4 is not limited to the case in which the gap G is 200 mm. A similar relation is established when the gap G is set, e.g., at any value between 150 mm and 250 mm, or at any value between 180 mm and 220 mm. Moreover, the value of L is not limited to a single value of 2G, and a predetermined width is allowed depending on the application and design, and an error of about 10% is allowed as an example. Therefore, the length L of the solenoid coil, which is approximately twice the gap G, is allowed to be set within a range of 1.8G to 2.2G. In this specification, the condition “L≅2G” means that L is any value within the range of 1.8G to 2.2G.

In the present embodiment, the length L of the solenoid coil 10 is configured to satisfy the condition of L≅2G. This makes it possible to design the rod-shaped core 20 in a shape that enables weight reduction while maintaining a high coupling coefficient k. In the solenoid coil unit 50 of this embodiment, the length L of the center portion 21 of the rod-shaped core 20 is designed to be more than twice the width w, i.e., L≥2w. In this way, since the rod-shaped core 20 can be formed into an elongated shape with a small width w, the length L of the solenoid coil 10 can be increased so that the coupling coefficient k becomes a desired high value while suppressing the increase in the weight of the solenoid coil unit 50.

In the solenoid coil unit 50, the length L of the center portion 21 in the center axis direction of the rod-shaped core 20 is preferably 3 times or more and even more preferably 4 times or more the width w of the center portion 21. It is also possible that the length L of the center portion 21 is 8 times or more the width w of the center portion 21, i.e., L≥8w. In this way, the solenoid coil 10 can be formed into a more elongated rod-like shape, and the coupling coefficient k of the solenoid coil 10 can be further increased while suppressing the increase in weight of the solenoid coil.

From the viewpoint of weight reduction alone, the thinner the rod-shaped core, the more effective it is. In practice, however, it is preferable that the maximum value of L/w is determined by considering the mechanical strength and the specifications of the insulated wire to be wound, as well as ensuring enough cross-sectional area to avoid saturation of magnetic flux density.

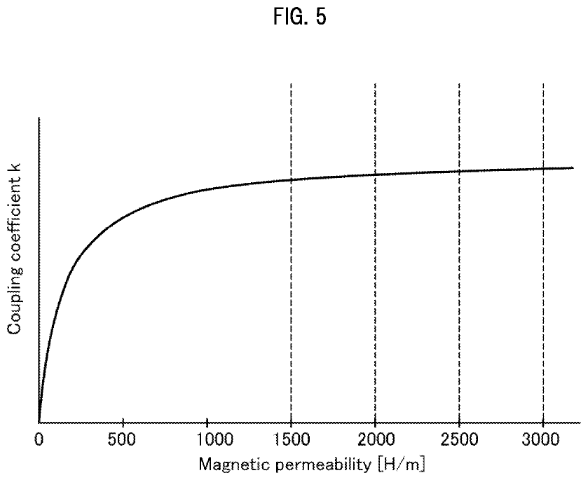

FIG. 5 shows a graph showing the coupling coefficient k when the magnetic permeability of the rod-shaped core 20 is changed in the contactless power transfer device 55. To obtain a high coupling coefficient k, the rod-shaped core 20 is preferably composed of a material with a magnetic permeability of 1,500 H/m or higher, and more preferably composed of a material with a magnetic permeability of 2,000 H/m or higher. It is even more preferable that the rod-shaped core 20 is composed of a material with a magnetic permeability of 2,500 H/m or higher. Also, the rod-shaped core 20 is not expected to have a significantly high coupling coefficient k even if it is composed of a material with a magnetic permeability higher than 3,000 H/m. Therefore, the rod-shaped core 20 is preferably composed of a material with a magnetic permeability of 3,000 H/m or less.

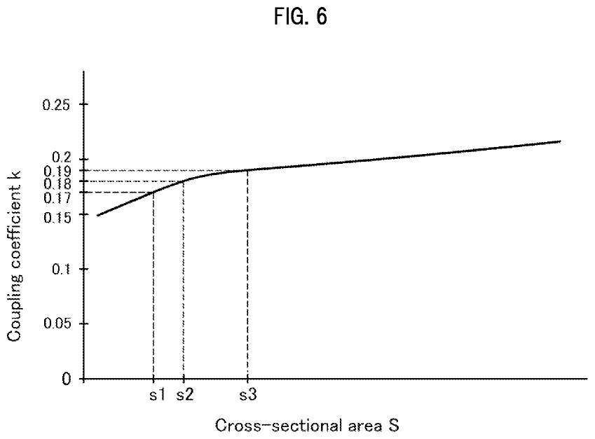

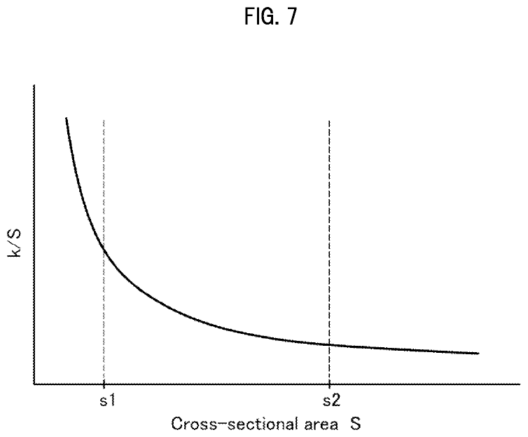

FIG. 6 is a graph showing the relation between the cross-sectional area S of the rod-shaped core 20 and the coupling coefficient k in the contactless power transfer device 55. FIG. 7 is a graph showing the relation between the cross-sectional area S and the ratio k/S of the coupling coefficient k to the cross-sectional area S of the rod-shaped core 20. The graphs in FIGS. 6 and 7 were originally obtained by the inventors of the present invention after intensive study. The coupling coefficient k in the graphs in FIGS. 6 and 7 is the value when the gap G between the two solenoid coil units 10, 10a is 200 mm. In the graphs of FIGS. 6 and 7, the region where the cross-sectional area S is s1 or more and less than s2 corresponds to the region where the coupling coefficient k is 1.7 or more and less than 2.0.

The cross-sectional area S of the rod-shaped core 20 corresponds to the cross-sectional area of the center portion 21 in the cross section orthogonal to the center axis direction. As shown in FIG. 6, the larger the cross-sectional area S of the rod-shaped core 20, the higher the coupling coefficient k can be. However, increasing the cross-sectional area S leads to a larger rod-shaped core 20, which leads to an increase in the weight of the solenoid coil unit 50.

Here, as shown in FIGS. 6 and 7, in the region where the coupling coefficient k is 0.2 or more, the coupling coefficient k does not increase much even if the cross-sectional area S is increased. Increasing the cross-sectional area S so that the coupling coefficient k is greater than 0.2 may significantly increase the weight of the rod-shaped core 20, which is not desirable. Therefore, in the solenoid coil unit 50, by designing the rod-shaped core 20 with a cross-sectional area S so that the coupling coefficient k is less than 0.2, it is possible to increase the value of the coupling coefficient k per weight of the solenoid coil unit 50, reduce the weight, and improve the power supply performance.

In addition, as shown in FIGS. 6 and 7, in the region where the coupling coefficient k is less than 0.17, the decrease in the coupling coefficient k with respect to the decrease in the cross-sectional area S becomes remarkably large. Therefore, it is highly likely that the power supply performance will be significantly degraded in the cross-sectional area S where the coupling coefficient k is less than 0.17 even if the solenoid coil unit 50 can be made lighter. Therefore, in the solenoid coil unit 50, it is preferable to design the rod-shaped core 20 with a cross-sectional area S so that the coupling coefficient k is 0.17 or more.

Thus, in the solenoid coil unit 50, it is preferable to design the rod-shaped core 20 so that the coupling coefficient k is 0.17 or more and less than 0.2. Since a higher coupling coefficient k is more preferable, it is preferable to design the rod-shaped core 20 so that the coupling coefficient k is 0.175 or more and more preferable to design the rod-shaped core 20 so that the coupling coefficient k is 0.18 or more in the solenoid coil unit 50. It is even more preferable to design the solenoid coil unit 50 so that the coupling coefficient k is 0.19 or more.

In addition, the inventors of the present invention found that, based on the graphs in FIGS. 6 and 7, in the rod-shaped core 20, the ratio L/w of the length L to the width w of the center portion 21 preferably satisfies the relation of 2≤L/w≤16. By satisfying this relation, the cross-sectional area S of the rod-shaped core 20 can be restrained from becoming too small, thereby avoiding that the coupling coefficient k is too low. In addition, the cross-sectional area S of the rod-shaped core 20 can be restrained from becoming too large, thereby avoiding that the solenoid coil unit 50 is too heavy.

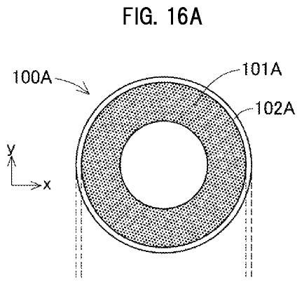

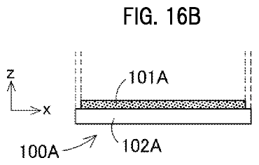

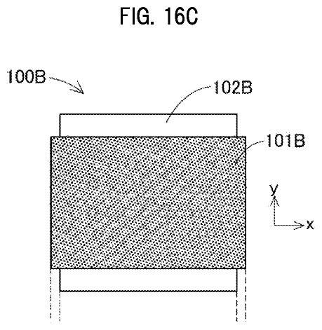

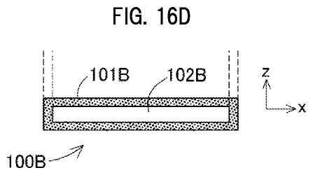

In the present embodiment, the solenoid coil 10 of the solenoid coil unit 50 is of the solenoid type and therefore more robust in contactless power transfer than the conventional circular type coil unit shown in FIGS. 16A and 16B. In addition, the solenoid coil unit 50 having a length in the center axis direction longer than that of the conventional solenoid-type coil unit is more robust than the conventional solenoid-type coil unit against misalignment in the center axis direction during contactless power transfer.

As described above, the solenoid coil unit 50 and the contactless power transfer device 55 equipped with the solenoid coil unit 50 of the present embodiment can improve the coupling coefficient and robustness while reducing the weight.

### 2. Second Embodiment

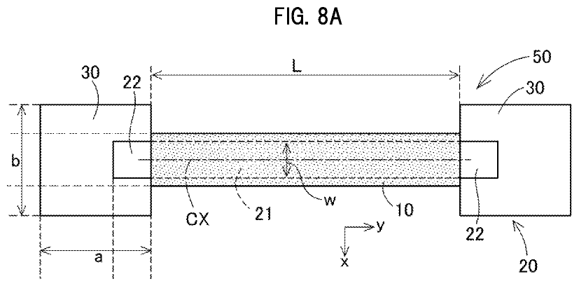

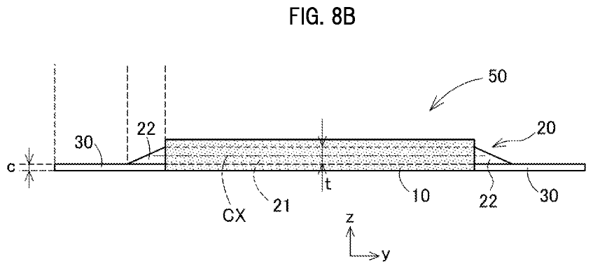

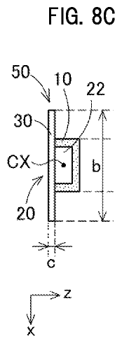

FIGS. 8A, 8B, and 8C show a schematic plan view, a schematic front view, and a schematic side view of the solenoid coil unit 50A according to a second embodiment, respectively. The configuration of the solenoid coil unit 50A of the second embodiment is almost the same as that of the solenoid coil unit 50 described in the first embodiment, except that additional magnetic pole portions 30 are provided at each of the two end portions 22 of the rod-shaped core 20.

The additional magnetic pole portions 30 extend from the end portions 22 of the rod-shaped core 20 and are constructed as a plate-like member smaller in thickness than the center portion 21. In the second embodiment, the additional magnetic pole portions 30 at each of the end portions 22 have the same shape. In the second embodiment, the additional magnetic pole portion 30 has a nearly rectangular shape when viewed in the thickness direction and extends from the end portion 22 in the x- and y-directions. As shown in FIGS. 8A, 8B and 8C, in the second embodiment, the end portion 22 is located at the center of the additional magnetic pole portion 22 in the x-direction, and the thickness thereof gradually decreases in the direction away from the center portion 21.

The thickness c of the additional magnetic pole portion 30 is constant. From the viewpoint of weight reduction of the solenoid coil unit 50A, a smaller thickness c of the additional magnetic pole portion 30 is preferable. The thickness c of the additional magnetic pole portion 30 is preferably ½ or less and more preferably ⅓ or less of the thickness t of the center portion 21. It is more preferable that the thickness c of the additional magnetic pole portion 30 is ⅕ or less of the thickness t of the center portion 21. In another embodiment, the thickness c of the additional magnetic pole portion 30 need not be constant. The additional magnetic pole portion 30 may have a configuration in which the thickness changes continuously in the width direction or length direction, for example. In this case, the aforementioned thickness c may be the maximum value of the thickness of the additional magnetic pole portion 30.

In the second embodiment, the additional magnetic pole portions 30 are made of the same magnetic material as the rod-shaped core 20 and are made integrally with the rod-shaped core 20. In another embodiment, the additional magnetic pole portions 30 may be configured separately from the rod-shaped core 20 and may be retrofitted to the end portions 22 by joining. The additional magnetic pole portions 30 may be composed of a type of magnetic material different from the rod-shaped core 20.

As will be described later, the solenoid coil unit 50A with the additional magnetic pole portions 30 can increase the coupling coefficient k while suppressing the increase in weight, and enhance the robustness against misalignment.

It should be noted that the shape of the plate surface of the additional magnetic pole portion 30 is not limited to the approximately rectangular shape. In other embodiments, the shape of the plate surface of the additional magnetic pole portion 30 may be, e.g., triangular shape, polygonal shape, circular shape, or elliptical shape. In addition, the shapes of the plate surface of the additional magnetic pole portions 30 may be different between one end portion 22 and the other end portion 22. In the second embodiment, the additional magnetic pole portion 30 extends in the width direction from the end portion 22, and the width b of the additional magnetic pole portion 30 is larger than the width w of the end portion 22 of the rod-shaped core 20. Alternatively, in another embodiment, the additional magnetic pole portion 30 may only extend in the center axis direction without extending in the width direction from the end portion 22. On the contrary, the additional magnetic pole portion 30 may only extend in the width direction without extending in the center axis direction from the end portion 22.

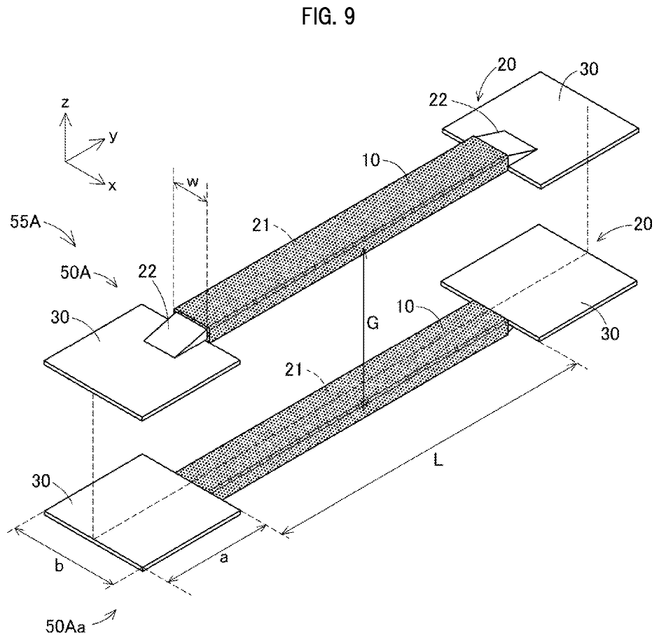

FIG. 9 is a schematic diagram illustrating a contactless power transfer device 55A using a solenoid coil unit 50A of the second embodiment. The contactless power transfer device 55A includes a first solenoid coil unit 50A and a second solenoid coil unit 50Aa. The second solenoid coil unit 50Aa has the same configuration as the first solenoid coil unit 50A and includes the solenoid coil 10 and the rod-shaped core 20 provided with additional magnetic pole portions 30. The second solenoid coil unit 50Aa has the same self-inductance as the first solenoid coil unit 50A. The dimensions of the additional magnetic pole portions 30 are also the same.

In the contactless power transfer device 55A, the first solenoid coil unit 50A is arranged in parallel with the second solenoid coil unit 50Aa, which is another solenoid coil unit for performing contactless power transfer by mutual induction, by a predetermined gap G in the separation direction. The separation direction is along the z-direction as in the first embodiment. In the contactless power transfer device 55A, as in the contactless power transfer device 55 of the first embodiment, the pair of solenoid coil units 50A, 50Aa are arranged without being misaligned from each other. In this arrangement, the additional magnetic pole portions 30 of the first solenoid coil unit 50A and the additional magnetic pole portions 30 of the second solenoid coil unit 50Aa are arranged in parallel so that their plate surfaces face each other in the separation direction.

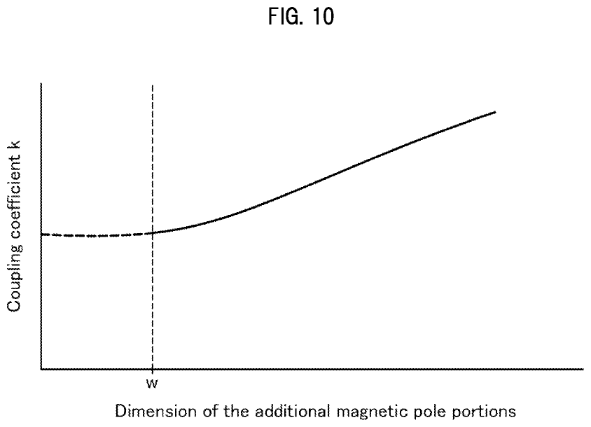

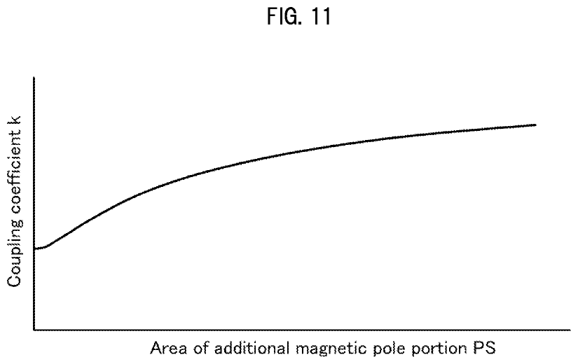

FIG. 10 is a graph showing the relation between the dimension of the additional magnetic pole portions 30 and the coupling coefficient k. FIG. 11 is a graph showing the relation between the area PS of the additional magnetic pole portions 30 and the coupling coefficient k. The graphs in FIGS. 10 and 11 were obtained through experiments by the inventors of the present invention.

The coupling coefficient k in this experiment was measured between the pair of solenoid coil units 50A, 50Aa with the same configuration shown in FIG. 9. In this experiment, the additional magnetic pole portion 30 has a nearly square-shaped plate surface in which the length a and the width b are equal. The dimension of the additional magnetic pole portion 30 in FIG. 10 corresponds to the width b of the additional magnetic pole portion 30. The area PS of the additional magnetic pole portion 30 in FIG. 11 includes the area of the side of the end portion 22 and corresponds to the value obtained by multiplying the length a by width b of the additional magnetic pole portion 30. That is, PS=a*b.

The solid line of the graph in FIG. 10 shows that the more the additional magnetic pole portion 30 extends beyond the end portion 22, the larger the coupling coefficient k becomes. In addition, the graph in FIG. 11 shows that the larger the area of the additional magnetic pole portion 30, the larger the coupling coefficient k.

Here, the magnetoresistance R in the magnetic circuit composed of the two solenoid coil units 50A, 50Aa is expressed by the following Equation 1. As Equation 1 shows, the larger the area PS of the additional magnetic pole portion 30, the smaller the magnetoresistance R and the larger the magnetic flux. Therefore, it is apparent that increasing the dimensions a and b of the additional magnetic pole portion 30 to increase the area PS can increase the coupling coefficient k.

$$R = \frac{l}{μ \cdot PS} \qquad Equation 1$$

(R: magnetoresistance l: magnetic path length magnetic permeability PS: area of the additional magnetic pole portion)

In the case of the additional magnetic pole portion 30, increasing the dimension thereof can easily increase the coupling coefficient k compared with the case of increasing the length L or the cross-sectional area S of the center portion 21 of the rod-shaped core 20. In addition, since the additional magnetic pole portion 30 has a plate-like shape, it is easy to reduce the weight by adjusting the thickness c. Therefore, in the case of the solenoid coil unit 50A of the second embodiment, the coupling coefficient k can be increased by providing the additional magnetic pole portion 30 even when the length L and the cross-sectional area S of the center portion 21 of the rod-shaped core 20 are reduced to reduce the weight. In other words, the solenoid coil unit 50A of the second embodiment can easily increase the coupling coefficient k while suppressing the increase in weight.

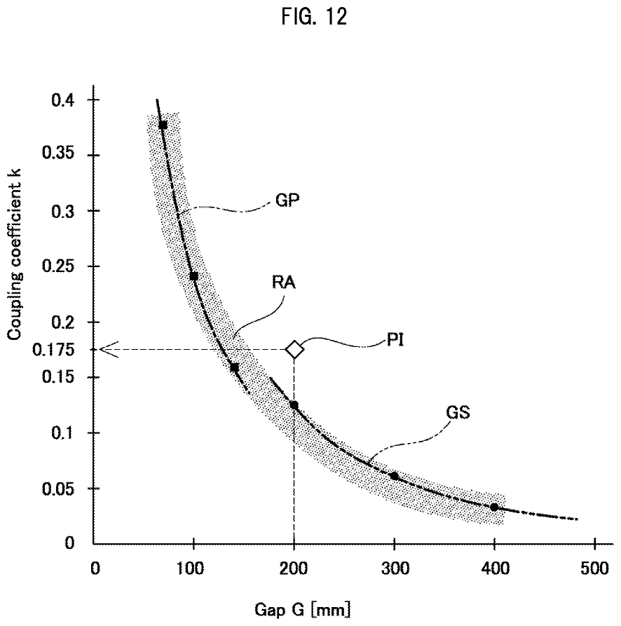

FIG. 12 is a graph showing an example of the relation between the gap G between coil units and the coupling coefficient k in a contactless power transfer device using conventional coil units. The first graph GP, shown as a dash-dotted line, illustrates an example of the relation between the gap G and the coupling coefficient k obtained in the conventional circular-type coil unit 100A shown in FIGS. 16A and 16B. The second graph GS, shown as a dashed double-dotted line, illustrates an example of the relation between the gap G and the coupling coefficient k obtained in the conventional solenoid coil unit 100B with the flat ferrite core 102B shown in FIGS. 16C and 16D. In contactless power transfer using conventional coil units 100A and 100B, the gap G and the coupling coefficient k are generally in a so-called trade-off relation, i.e., the coupling coefficient k decreases as the gap G increases.

Here, the area RA hatched by halftone dot around the two graphs GP, GS illustrates the approximate range of power transfer performance achieved by the conventional technology. Hereafter, the area RA is also referred to as “reference area RA”. It can be said that a coupling coefficient k plotted in the upper right region above the reference region RA in FIG. 12 indicates a contactless power transfer device having a power transfer performance more efficient than the conventional one. In contrast, a coupling coefficient k plotted in the lower left region of the reference area RA indicates a contactless power transfer device having a power transfer performance less efficient than the conventional one.

Now, explanation will be made with reference to Table 1 below. As an example of the second embodiment, the inventors of the present invention prepared a production example E of a solenoid coil unit 50A with L=420 mm, w=50 mm, t=15 mm, a=150 mm, b=150 mm, and c=3 mm in the configuration of the solenoid coil unit 50A shown in FIGS. 8A, 8B, and 8C.

TABLE 1

| | Dimention of center | | | Dimention of additinal | | |
|---|---|---|---|---|---|---|
| Production | portion [mm] | | | magnetic pole portion [mm] | | |
| example | L | w | t | a | b | c |
| E | 420 | 50 | 15 | 150 | 150 | 3 |

Using the production example E, the inventors of the present invention manufactured the contactless power transfer device 55A shown in FIG. 9 and determined the coupling coefficient k when the gap G=200 mm. The results are plotted as point PI in FIG. 12. In this example, the value of the coupling coefficient k is 0.175, which indicates that the power transfer performance is more efficient compared with the conventional one.

Thus, in the configuration of the solenoid coil unit 50A of the second embodiment, by providing the additional magnetic pole portion 30, it is possible to further increase the coupling coefficient k while suppressing the increase in weight. According to the solenoid coil unit 50A of the second embodiment, not only when the gap G is 200 mm, but also when the gap G is set, e.g., with an arbitrary value within a range of 150 mm or more and 250 mm or less, or with an arbitrary value within a range of 180 mm or more and 220 mm or less, the coupling coefficient k can be 0.18 or more or 0.2 or more.

Next, the weight of the above production example E was compared with solenoid coil units using a conventional flat core and an H-shaped core. The results are shown in Table 2 below. The solenoid coil unit of the comparative example exhibited a coupling coefficient k equivalent to that of the production example E when the gap G was as short as 70 to 100 mm. In other words, the production example E was lighter than the comparison example and exhibited a power transfer performance higher than the comparison example. In the solenoid coil unit of the comparative example, in order to achieve an equivalent coupling coefficient k with the gap G being set at 200 mm, the length of the coil or core may need to be about 2 times, and the area may need to be about 4 times, resulting in an increase in weight.

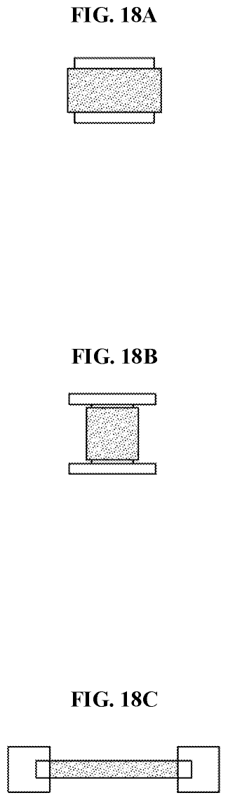

TABLE 2

| | Solenoid type | | |
|---|---|---|---|
| | Flat Core | H-shaped core | |
| | Comparative | Comparative | |
| | example | example | Production example E |
| Shape of | FIG. 18A | FIG. 18B | FIG. 18C |
| core | | | |
| Weight | About 4.6 kg | About 3.9 kg | About 2.4 kg |

| | | |
|---|---|---|
| Gap G | 70-100 mm | 200 mm |

As shown in Table 2, in comparison with the solenoid coil units using the conventional flat core or H-shaped core, the solenoid coil unit 50A of the second embodiment can be made significantly lighter while increasing the power transfer performance so that the solenoid coil unit 50A can be mounted on, e.g., an electric vehicle practically.

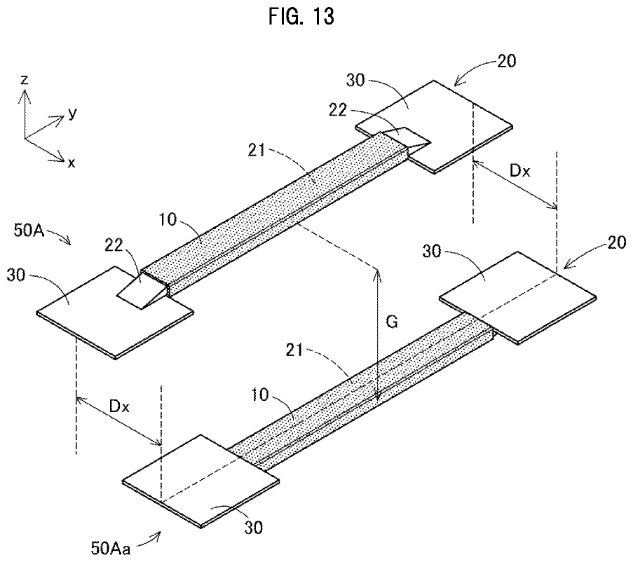

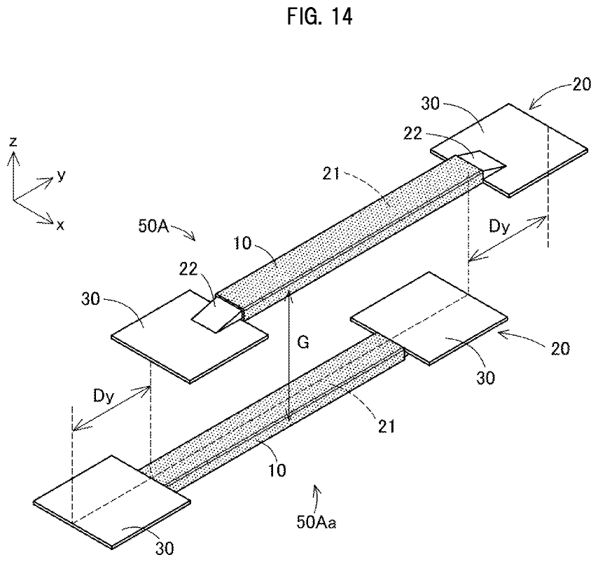

The robustness of the solenoid coil unit 50A is described with reference to FIGS. 13 and 14. FIG. 13 schematically illustrates an arrangement state of the pair of solenoid coil units 50A, 50Aa constituting the contactless power transfer device 55A misaligned in the x-direction by a distance Dx. FIG. 14 schematically illustrates an arrangement state of the pair of solenoid coil units 50A, 50Aa misaligned in the y-direction by a distance Dy.

In the case of the contactless power transfer device 55A employing the solenoid coil unit 50A of the second embodiment, even if misalignment occurs, the reduction of the coupling coefficient k due to misalignment is suppressed by the effect of the additional magnetic pole portion 30. This can achieve high robustness against misalignment between the pair of solenoid coil units 50A, 50Aa.

In the solenoid coil unit 50A, the width b of the additional magnetic pole portion 30 is preferably larger than the width w of the center portion 21. Thus, robustness against misalignment in the width direction can be enhanced by the effect of the additional magnetic pole portion 30 extending in the width direction. In addition, in the solenoid coil unit 50A, it is desirable that the length a and the width b of the additional magnetic pole portion 30 are the same. This can increase robustness against misalignment in both the center axis and width directions.

The following is a description of the results of an experiment conducted by the inventors of the present invention on the robustness of the contactless power transfer device 55A against misalignment. In this experiment, the contactless power transfer device 55A with the gap G of 200 mm was produced by using the above production example E, and the contactless power transfer was performed in a state in which the coil units were misaligned in the x- and y-directions, respectively, by 150 mm.

Here, the inductance L is generally expressed by Equation 2. When misalignment occurs as shown in FIGS. 13 and 14, the magnetic poles mutually overlap in the separation direction so that the inductance L decreases due to the decrease in the area S and the increase in the magnetic path length 1. In this experimental example, since the capacitance C of the capacitor used in the electric circuit is constant, the decrease in the inductance L is compensated by increasing the resonance frequency f on the basis of Equation 3.

$$L = {n}^{2} \frac{μ S}{l} \qquad Equation 2$$

(L: inductance n: coil turns μ: magnetic permeability S: area is magnetic path length)

$$\begin{matrix}{ω}_{0} = 2 π f = \frac{1}{\sqrt{LC}} & f = \frac{1}{2 π \sqrt{LC}}\end{matrix} \qquad Equation 3$$

(f: resonance frequency C: capacitance)

Table 3 shows the results of this experiment. In the case of a 150 mm misalignment in the width direction, the efficiency of 92.5% decreases to 85.0%; however, it was found that the efficiency can be increased to 91.6% by adjusting the frequency as described above. In the case of a 150 mm misalignment in the center axis direction, the efficiency of 92.2% decreases to 81.9%. It was found that, however, the efficiency can be increased to 91.0% by adjusting the frequency in the same way.

TABLE 3

| Amount of | Width direction (x-direction) | | | | Center axis direction (y-direction) | | | |
|---|---|---|---|---|---|---|---|---|
| misalignment | Frequency | Input | Output | Efficiency | Frequency | Input | Output | Efficiency |
| 0 mm | 31.7 kHz | 24.75 W | 22.88 W | 92.5% | 31.7 kHz | 24.25 W | 22.36 W | 92.2% |
| 150 mm | 31.7 kHz | 34.95 W | 29.72 W | 85.0% | 31.7 kHz | 43.25 W | 35.4 W | 81.9% |
| | 32.3 kHz | 25.0 W | 22.36 W | 89.4% | 32.1 kHz | 36.25 W | 32.19 W | 88.0% |
| | 32.7 kHz | 21.63 W | 19.8 W | 91.6% | 32.3 kHz | 26.25 W | 23.7 W | 91.0% |
| | 33.1 kHz | 18.3 W | 16.04 W | 87.6% | 32.7 kHz | 28.7 W | 23.3 W | 82.0% |

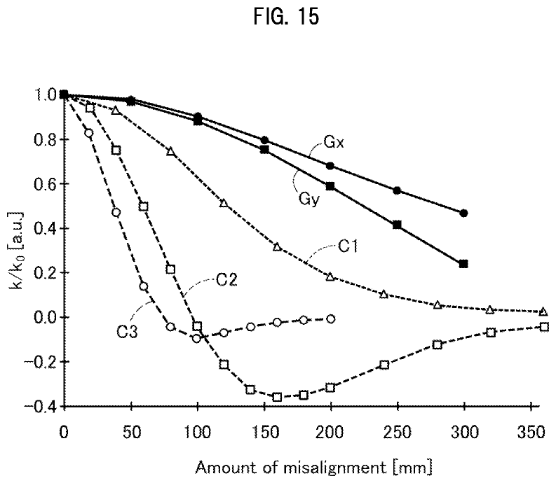

FIG. 15 is a graph showing the change in the coupling coefficient k when the coil units are misaligned in the x-direction, which is the width direction, and in the y-direction, which is the center axis direction. In FIG. 15, the horizontal axis shows the amount of misalignment in mm (millimeter), and the vertical axis shows the coupling coefficient k/k₀ normalized to 1.0 at no misalignment.

The graphs Gx, Gy were obtained in the contactless power transfer device 55A using the above production example E. Graph Gx shows the case of misalignment in the x-direction and graph Gy shows the case of misalignment in the y-direction.

Graphs C1 to C3 of the comparative examples are graphs based on the coupling coefficients disclosed in Non-patent Document 1. Graph C1 of the comparative example shows the case of misalignment in the x-direction in a configuration using an H-shaped core. Graph C2 of the comparative example shows the case of misalignment in the y-direction in a configuration using an H-shaped core. Graph C3 of the comparative example shows the case of misalignment in a configuration using a circular-type coil unit. Note that there is no directional dependence in the x- and y-directions for the misalignment in the circular-type coil unit.

FIG. 15 shows that, by using the production example E of the solenoid coil unit 50A, even when the misalignment reaches 300 mm, power can be transferred with the coupling coefficient k maintained at 45% or more for misalignment in the x-direction and 20% or more for misalignment in the y-direction. In contrast, all of the graphs C1 to C3 of the comparative example show that the coupling coefficient k decreases rapidly as the amount of misalignment increases. In graph C1 of the comparative example, the coupling coefficient k becomes almost 0 when the misalignment amount is 300 mm, and in graphs C2 and C3 of the comparative example, the coupling coefficient k becomes less than 0 when the misalignment amount reaches 100 mm, and there exists a dead spot where power cannot be transferred.

As a result of evaluating the effect of misalignment on the transmission efficiency of power, it was confirmed that the present invention has a high robustness against the misalignments in both the x- and y-directions. This will make contactless power transfer technology to be more widely applied and dynamic power transfer to an electric vehicle to be more practical.

As described above, the solenoid coil unit 50A of the second embodiment and the contactless power transfer device 55A employing the same can still further improve the coupling coefficient and robustness while reducing the weight by providing the additional magnetic pole portions 30.

### 3. Conclusion

As shown in Table 4, a conventional circular-type coil unit, a solenoid-type coil unit with a flat core, or a solenoid-type coil unit with an H-shaped core does not satisfy any of the criteria for coupling coefficient, robustness, or weight reduction. In contrast, the solenoid coil units 50, 50A of the first and second embodiment can achieve all of the coupling coefficient, robustness, and weight reduction as described above. In addition, in a conventional circular-type coil unit or a solenoid-type coil unit with a flat core, a dead spot occurs when the misalignment becomes large. In a solenoid-type coil unit with an H-shaped core, a dead spot may occur depending on the direction of misalignment. On the other hand, according to the solenoid coil units 50, 50A of the first and second embodiment, the occurrence of dead spots due to misalignment can be suppressed more than those conventional solenoid coil units.

TABLE 4

| | | Type | | | |
|---|---|---|---|---|---|
| | | | | | Solenoid- |
| | | | | | type coil |
| | | | | | unit of first |
| | | | Solenoid-type | | embodiment |
| | | Circular- | Flat | H-shaped | and second |
| Evaluation item | | type | core | core | embodiment |
| Coupling coefficient | | Excellent | Average | Average | Excellent |
| Robustness | x- | Poor | Excellent | Excellent | Excellent |
| | direction | | | | |
| | y- | Poor | Poor | Poor | Excellent |
| | direction | | | | |

| | | | | |
|---|---|---|---|---|
| Weight reduction | Poor | Poor | Average | Excellent |
| Suppression of | Poor | Poor | Average | Excellent |
| dead spot | | | | |

Although the preferred embodiments and examples of the present invention have been described above, the present invention is not limited to such embodiments and examples. The compositions disclosed in the present application may be changed or modified in various ways within the scope of the technical sprit of the present invention. For example, the solenoid coil units 50, 50A of the above first and second embodiments may be used for contactless power transfer with other coil units having different configurations.

### REFERENCE SIGNS LIST

10 solenoid coil
20 rod-shaped core
21 center portion
22 end portion
30 additional magnetic pole portion
50a, 50A, 50Aa solenoid coil unit
55, 55a contactless power transfer device
100A, 100B coil unit
101A circular-type coil
101B solenoid-type coil
102A disk-shaped ferrite core
102B flat ferrite core
CX center axis
MF magnetic flux

1. A solenoid coil unit that transfers power with another solenoid coil unit in a non-contact manner, comprising:
a solenoid coil that is to be arranged in parallel with another solenoid coil provided in the other solenoid coil unit with a predetermined gap in a separation direction orthogonal to a center axis direction; and
a rod-shaped core around which the solenoid coil is wound and having a length longer than the length of the solenoid coil in the center axis direction,
wherein the rod-shaped core has a center portion around which the solenoid coil is wound and end portions extending from both ends of the solenoid coil,
wherein the ratio of the length to the width of the center portion is 2 or more, and
wherein the length of the solenoid coil in the center axis direction is approximately twice the gap.

2. The solenoid coil unit according to claim 1,
wherein the ratio of the length to the width of the center portion is 8 or more.

3. The solenoid coil unit according to claim 1,
wherein the relation 2≤L/w≤16 is satisfied, in which L represents the length of the center portion and w represents the width of the center portion.

4. The solenoid coil unit according to claim 1,
wherein the coupling coefficient k is 0.17 or more and less than 0.2 when the other solenoid coil unit comprising the other solenoid coil of the same configuration as the solenoid coil and the other rod-shaped core of the same configuration as the rod-shaped core is arranged without misalignment with the gap of 200 mm with respect to the solenoid coil unit.

5. The solenoid coil unit according to claim 1,
wherein the end portion is provided with plate-like additional magnetic pole portions that are smaller in thickness than the center portion and extend from the end portions.

6. The solenoid coil unit according to claim 5,
wherein the width of the additional magnetic pole portions is greater than the width of the center portion.

7. The solenoid coil unit according to claim 5, wherein the length and width of the additional magnetic pole portions are equal.

8. A contactless power transfer device, comprising:
a first solenoid coil unit which is the solenoid coil unit according to claim 1; and
a second solenoid coil unit which is the other solenoid coil unit,
the contactless power transfer device transferring power by causing mutual induction between the first solenoid coil unit and the second solenoid coil unit.

9. The solenoid coil unit according to claim 6, wherein the length and width of the additional magnetic pole portions are equal.

10. The solenoid coil unit according to claim 2,
wherein the coupling coefficient k is 0.17 or more and less than 0.2 when the other solenoid coil unit comprising the other solenoid coil of the same configuration as the solenoid coil and the other rod-shaped core of the same configuration as the rod-shaped core is arranged without misalignment with the gap of 200 mm with respect to the solenoid coil unit.

11. The solenoid coil unit according claim 3,
wherein the coupling coefficient k is 0.17 or more and less than 0.2 when the other solenoid coil unit comprising the other solenoid coil of the same configuration as the solenoid coil and the other rod-shaped core of the same configuration as the rod-shaped core is arranged without misalignment with the gap of 200 mm with respect to the solenoid coil unit.

12. The solenoid coil unit according to claim 2,
wherein the end portion is provided with plate-like additional magnetic pole portions that are smaller in thickness than the center portion and extend from the end portions.

13. The solenoid coil unit according to claim 12,
wherein the width of the additional magnetic pole portions is greater than the width of the center portion.

14. The solenoid coil unit according to claim 12,
wherein the length and width of the additional magnetic pole portions are equal.

15. The solenoid coil unit according to claim 13,
wherein the length and width of the additional magnetic pole portions are equal.

16. The solenoid coil unit according to claim 3,
wherein the end portion is provided with plate-like additional magnetic pole portions that are smaller in thickness than the center portion and extend from the end portions.

17. The solenoid coil unit according to claim 16,
wherein the width of the additional magnetic pole portions is greater than the width of the center portion.

18. The solenoid coil unit according to claim 16,
wherein the length and width of the additional magnetic pole portions are equal.

19. The solenoid coil unit according to claim 17,
wherein the length and width of the additional magnetic pole portions are equal.

20. A contactless power transfer device, comprising:
a first solenoid coil unit which is the solenoid coil unit according claim 5; and
a second solenoid coil unit which is the other solenoid coil unit, the contactless power transfer device transferring power by causing mutual induction between the first solenoid coil unit and the second solenoid coil unit.
